(19) United States
(12) Patent Application Publication
(10) Pub. No.: US 2007/0247069 A1
(43) Pub. Date: Oct. 25, 2007

(54) Plasma display panel, plasma display apparatus and driving method thereof

(75) Inventor: Wonbae Park, Suwon-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/790,253

(22) Filed: Apr. 24, 2007

(30) Foreign Application Priority Data
Apr. 24, 2006 (KR) 10-2006-0036646

(51) Int. Cl. H01J 17/49

(52) U.S. Cl. 313/582

(57) ABSTRACT

A plasma display apparatus comprises a plasma display panel, a scan driver, a first address driver, and a second address driver. The plasma display panel includes a plurality of discharge cells corresponding to areas where at least one of a plurality of scan electrodes crosses a plurality of address electrodes. The scan driver supplies scan pulses to the plurality of the scan electrodes. The first address driver supplies data pulses to some of the plurality of the address electrodes. The second address driver receives the data pulses supplied to some of the plurality of the address electrodes and supplies data pulses to at least one of the rest address electrodes except for some of the plurality of the address electrodes.

This application claims the benefit of Korean Patent Application No. 10-2006-0036646 filed on Apr. 24, 2006, which is hereby incorporated by reference.

### BACKGROUND

1. Field

This document is related to a plasma display panel, a plasma display apparatus and a driving Method of the plasma display apparatus.

2. Description of the Related Art

A plasma display apparatus includes a plasma display panel and a driver. The plasma display panel includes a discharge cell partitioned by a barrier rib. The driver supplies a driving signal to an electrode of the plasma display panel. As a result of a supply of the driving signal, a discharge occurs in the discharge cell, and excites a phosphor of the discharge cell. When the discharge excites the discharge cell, the phosphor generates light.

The plasma display apparatus achieves grey levels with a combination of subfields. The plasma display apparatus emits light during each subfield, and the grey levels are achieved by a sum of light amount emitted during each subfield.

Each subfield includes a reset period, an address period, and a sustain period. During the reset period, wall discharges of entire discharge cells of the plasma display panel are uniformed. Some discharge cells of the entire discharge cells are selected during the address period. The selected discharge cells emit light during the sustain period.

### SUMMARY

In one aspect, a plasma display panel comprises a first panel including a plurality of scan electrodes, a second panel including a plurality of address electrodes crossing the plurality of the scan electrodes, a barrier rib partitioning four discharge cells corresponding to regions where at least one of the plurality of the scan electrodes cross the plurality of address electrodes and a plurality of phosphors emitting different lights each other from the four discharge cells.

The plurality of phosphors may include a red phosphor, a green phosphor, a blue phosphor, and a fourth phosphor.

The fourth phosphor may be a white phosphor.

The plurality of scan electrodes may include a first scan electrode and a second scan electrode, some of the four discharge cells may correspond to the first scan electrode, and the rest of the four discharge cells except for some discharge cells may correspond to the second scan electrode.

The four discharge cells may correspond to one scan electrode of the plurality of scan electrodes.

Each area of the discharge cells, which the barrier rib partitions, may be substantially the same.

A channel may be formed at the barrier rib.

In another aspect, a plasma display apparatus comprises a plasma display panel including a plurality of discharge cells corresponding to areas where at least one of a plurality of scan electrodes crosses a plurality of address electrodes, a scan driver supplying scan pulses to the plurality of the scan electrodes, a first address driver supplying data pulses to some of the plurality of the address electrodes and a second address driver receiving the data pulses supplied to some of the plurality of the address electrodes and supplying data pulses to at least one of the rest address electrodes except for some of the plurality of the address electrodes.

The second address driver may receive the data pulses having high level supplied to some of the plurality of the address electrodes and supply a data pulse having high level to at least one of the rest address electrodes.

The second address driver may include an AND gate receives the data pulses having high level supplied to some of the plurality of the address electrodes and generate a data pulse having high level to the rest address electrodes.

A red phosphor, a green phosphor and a blue phosphor may be positioned at discharge cells corresponding to some of the plurality of the address electrodes, and a fourth phosphor may be positioned at a discharge cell corresponding to at least one of the rest address electrodes.

The fourth phosphor may be a white phosphor.

The plurality of the scan electrodes may include a first scan electrode and a second scan electrode, some of the plurality of the discharge cells may correspond to the first scan electrode, and at least one of the rest discharge cells except for some of the plurality of the discharge cells may correspond to the second scan electrode.

The plurality of the discharge cells may correspond to one of the plurality of the scan electrodes.

Each of the the plurality of the discharge cells which the barrier rib partition may be substantially the same each other.

A channel may be formed at the barrier rib.

In still another aspect, a driving method of a plasma display apparatus including a plurality of discharge cells corresponding to areas where at least one of a plurality of scan electrodes crosses a plurality of address electrodes, comprises supplying scan pulses to the plurality of the scan electrodes, supplying data pulses to some of the plurality of the address electrodes and receiving the data pulses supplied to some of the plurality of the address electrodes and supplying data pulses to at least one of the rest address electrodes except for some of the plurality of the address electrodes.

The data pulses having high level supplied to some of the plurality of the address electrodes may be received and a data pulse having high level is supplied to at least one of the rest address electrodes.

A red phosphor, a green phosphor and a blue phosphor may be positioned at discharge cells corresponding to some of the plurality of the address electrodes, and a fourth phosphor may be positioned at a discharge cell corresponding to at least one of the rest address electrodes.

The fourth phosphor may be a white phosphor.

### BRIEF DESCRIPTION OF THE DRAWINGS

The embodiment will be described in detail with reference to the following drawings.

FIG. 1 illustrates a plasma display panel according to a first embodiment;

FIG. 2 illustrates a plasma display panel according to a second embodiment;

FIG. 3 illustrates a disposement of discharge cells of the plasma display panel according to the first embodiment;

FIG. 4 illustrates a plasma display apparatus according to an embodiment;

FIGS. 5a and 5b illustrate an example of an operation of a first address electrode driver and a second address electrode driver of FIG. 4; and

FIG. 6 illustrates another example of the operation of the first address electrode driver and the second address electrode driver of FIG. 4.

### DETAILED DESCRIPTION OF EMBODIMENTS

Embodiments will be described in a more detailed manner with reference to the drawings.

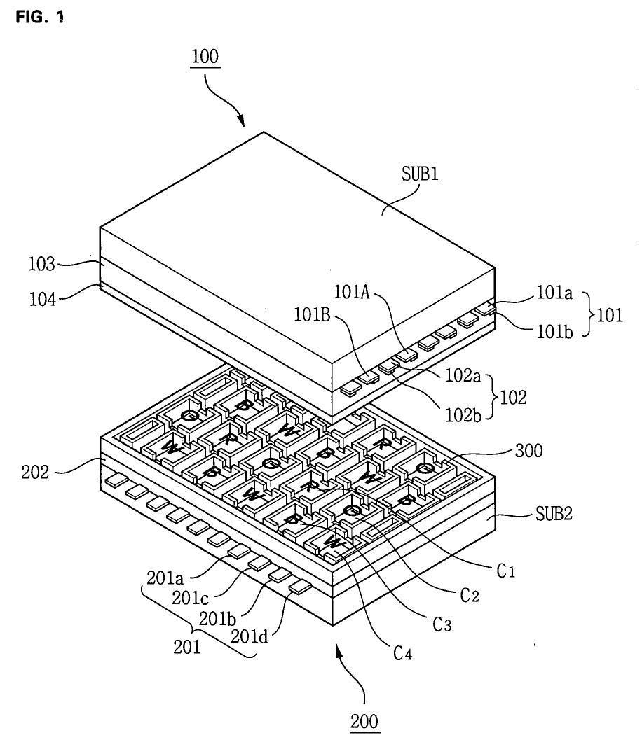

FIG. 1 illustrates a plasma display panel according to a first embodiment. As illustrated in FIG. 1, the plasma display panel according to the first embodiment includes a first panel 100, a second panel 200, a barrier rib 300 and a plurality of phosphors R, G, B and W.

The first panel 100 includes a plurality of scan electrodes 101 and a plurality of sustain electrodes 102. The scan electrode 101 and the sustain electrode 102 are disposed on the first substrate SUB1. The scan electrode 101 and the sustain electrode 102 include transparent electrodes 101a and 102a and bus electrodes 101b and 102b. The transparent electrodes 101a and 102a are made of ITO (Indium Tin Oxide), and diffuses a discharge according to a supply of a driving voltage. The bus electrodes 101b and 102b are made of metal having a resistance less than ITO. A first dielectric layer 103 covers the scan electrode 101 and the sustain electrode 102. The first dielectric layer 103 isolates the scan electrode 101 and the sustain electrode 102. A protective layer 104 is disposed on the first dielectric layer 103, and is made of magnesium oxide (MgO). The protective layer 104 facilitates a generation of discharge by emitting secondary electrons.

The second panel 200 includes a plurality of address electrodes 201 crossing the plurality of the scan electrodes 101 and the plurality of the sustain electrodes 102. The plurality of address electrodes 201 are disposed on a second substrate SUB2. A second dielectric layer 202 isolates the plurality of address electrodes 201. A barrier rib 203 partitions four discharge cells C1, C2, C3 and C4 corresponding to regions where at least one of the plurality of the scan electrodes 101 cross the plurality of address electrodes 201.

The four discharge cells C1, C2, and C3 are disposed in a delta type. The plurality of address electrodes 201 include a first electrode to a fourth electrode 201a, 201b, 201c and 201d which are adjacent each other. The plurality of the scan electrodes 101 includes a first scan electrode 101A and a second scan electrode 101B. Some discharge cells C1 and C2 of the four discharge cells C1, C2, C3 and C4 corresponds to the first scan electrode 101A. The rest C3 and C4 of the four discharge cells except for some discharge cells correspond to the second scan electrode 101B.

The phosphor is positioned inside of the discharge cell. The plurality of phosphors emit different lights each other from the four discharge cells C1, C2, C3 and C4. The plurality of phosphors may include a red phosphor R, a green phosphor G, a blue phosphor B, and a fourth phosphor. The fourth phosphor may be a white phosphor W. One pixel may comprise the four discharge cell C1, C2, C3 and C4.

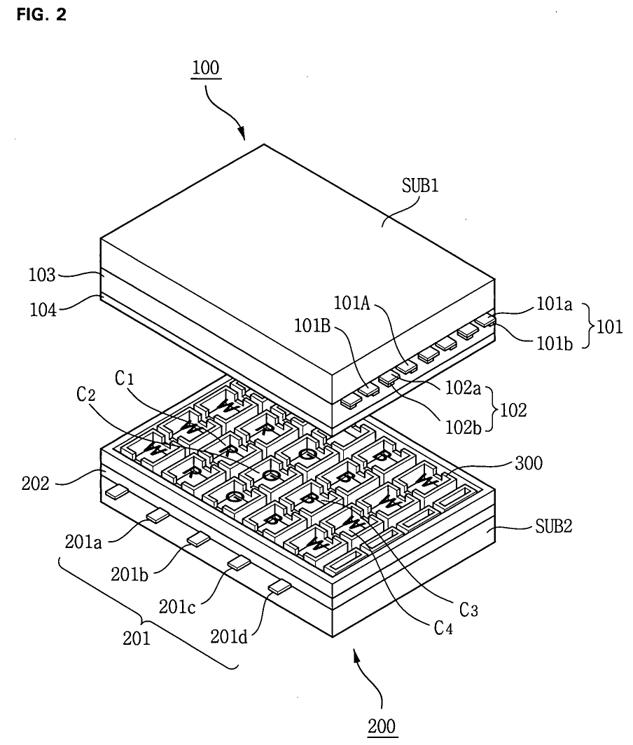

FIG. 2 illustrates a plasma display panel according to a second embodiment. In the first embodiment, some of the four discharge cells correspond to one scan electrode. In the second embodiment, all the four discharge cells correspond to one scan electrode.

The plurality of address electrodes include a first to a fourth address electrodes 201a, 201b, 201c and 201d adjacent one another, and the four discharge cells C1, C2, C3, and C4 correspond to one 101A or 101B of the plurality of the scan electrodes 101. One pixel of the second embodiment comprises the four discharge cells C1, C2, C3, and C4.

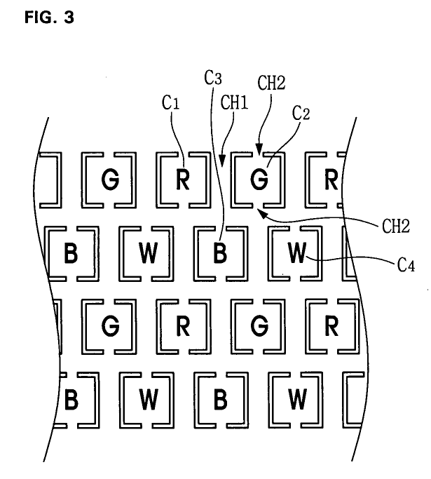

FIG. 3 illustrates a disposement of discharge cells of the plasma display panel according to the first embodiment. As illustrated in FIG. 3, one pixel of the plasma display panel according to the first embodiment includes three discharge cells C1, C2, and C3 disposed in the delta type and the fourth discharge cell C4. The RED phosphor R, the GREEN phosphor G, the BLUE phosphor B, and the WHITE phosphor W are formed in the four discharge cells. Each area of the discharge cells, which the barrier rib partitions, may be substantially the same each other. When each area of the discharge cells C1, C2, C3 and C4 is substantially the same each other, a plasma display panel is manufactured simply. An area of at least one of the four discharge cells C1, C2, C3 and C4 may be different from an area of the rest except for at least one of the four discharge cells C1, C2, C3 and C4. For example, the blue phosphor B may have an efficiency of light emission lower than an efficiency of light emission of other phosphors. Accordingly, when the area of the discharge cell C3 is greater than areas of other discharge cells C1, C2, and C4, a color temperature and a color coordinate can be maintained.

As illustrated in FIG. 3, a channel may be formed at the barrier rib. For example, the channel CH1 may be formed at the barrier rib partitioning a discharge cell C1 and a discharge cell C2. Another channel may be formed at the barrier rib partitioning an inside and an outside of a discharge cell. For example, a channel CH2 may be formed at a barrier rib partitioning the inside and the outside of the discharge cell C2. Accordingly, the channel CH1 and the channel CH2 may be connected each other. The channel CH1 and the channel CH2 facilitate an exhaust. When the channel CH1 and the channel facilitates the exhaust, unnecessary material is reduced and brightness of light emitted by a discharge cell increases.

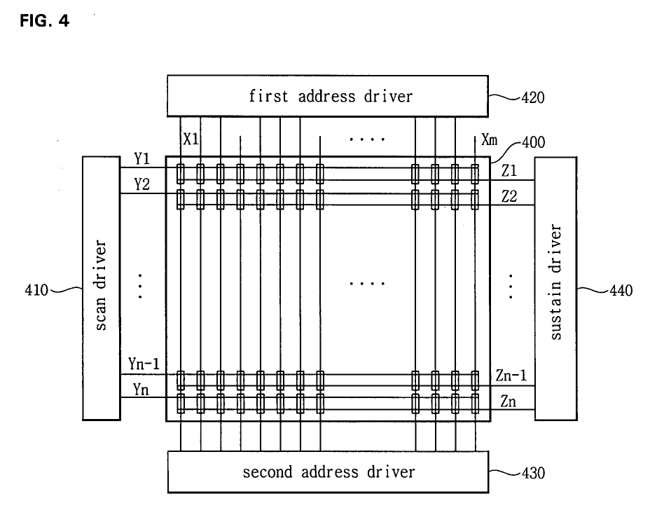

FIG. 4 illustrates a plasma display apparatus according to a first embodiment. As illustrated in FIG. 4, the plasma display apparatus according to the embodiment includes a plasma display panel 400, a scan driver 410, a first address driver 420, a second address driver 430 and a sustain driver 440.

The plasma display panel includes a plurality of discharge cells corresponding to areas where at least one of a plurality of scan electrodes Y1-Yn crosses a plurality of address electrodes X1-Xm.

The scan driver 410 supplies to the plurality of scan electrodes Y1-Yn a reset pulse for uniformity of wall charges of discharge cells. The scan driver 410 supplies scan pulses, which are for selecting discharge cells emitting light, to the plurality of the scan electrodes Y1-Yn. The scan driver 410 supplies sustain pulses to the scan electrodes Y1-Yn. The sustain pulses generate light from the selected discharge cells.

The first address driver 420 supplies data pulses to some of the plurality of the address electrodes X1-Xm. For example, the first address driver 420 may supply data pulses to one address electrode, two address electrodes or three address electrodes of four address electrodes corresponding to four discharge cells constituting one pixel.

The second address driver 430 receives the data pulses supplied to some of the plurality of the address electrodes X1-Xm, and supplies data pulses to at least one of the rest address electrodes except for some of the plurality of the address electrodes. For example, the first address driver 420 supplies data pulses to three address electrodes of four address electrodes. The address driver 430 receives the data pulses supplied to three address electrodes, and generates a data pulse supplied to one address electrode.

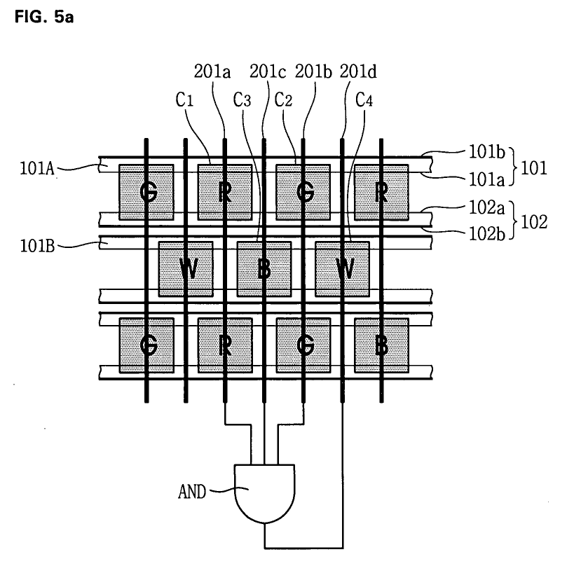

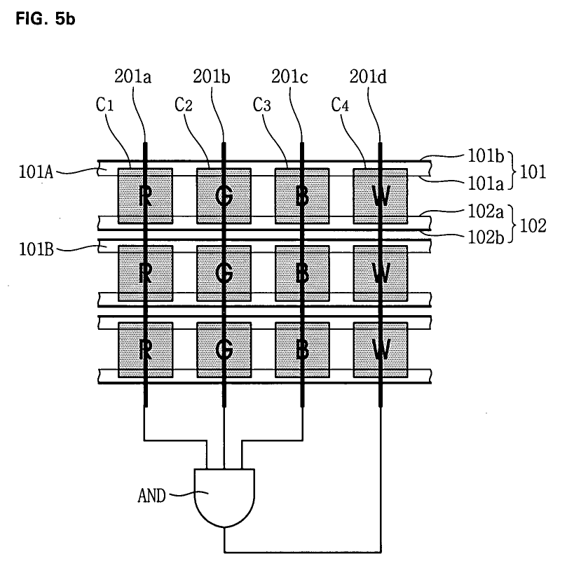

An operation of the address driver 420 and the second address driver 430 will be described in detail with reference to FIGS. 5a and 5b.

FIGS. 5a and 5b illustrate an example of an operation of a first address electrode driver and a second address electrode driver of FIG. 4. As illustrated in FIG. 5a, a disposement of discharges is the same as a disposement of discharge cells of FIG. 1. A RED discharge cell C1, a GREEN discharge cell C2, a BLUE discharge cell C3 and a WHITE discharge cell C4 constitute one pixel. A RED phosphor, a GREEN phosphor, a BLUE phosphor and a WHITE phosphor are respectively dispositioned in the RED discharge cell C1, the GREEN discharge cell C2, the BLUE discharge cell C3 and the WHITE discharge cell C4. The RED discharge cell C1, the GREEN discharge cell C2, and the BLUE discharge cell C3 RED are disposed in delta type.

Each discharge cell corresponds to an area where a scan electrode 101 and a sustain electrode 102 cross address electrodes 201a, 201b, 201c and 201d. Reference numerals 101a and 102a correspond to transparent electrodes of the scan electrode 101 and the sustain electrode 102, and reference numeral 101b and 102b correspond to bus electrodes of the scan electrode 101 and the sustain electrode 102.

The second address driver 430 receives the data pulses having high level supplied to some 201a, 201b, 201c of the plurality of the address electrodes 201a, 201b, 201c and 201d and supplies a data pulse having high level to at least one 201d of the rest address electrodes.

The second address driver 430 may include an AND gate AND receives the data pulses having high level supplied to some 201a, 201b, and 201c of the plurality of the address electrodes 201a, 201b, 201c and 201d, and generates a data pulse having high level to at least one 201d of the rest address electrodes.

A red phosphor, A green phosphor and A blue phosphor are positioned at discharge cells corresponding to some 201a, 201b, and 201c of the plurality of the address electrodes 201a, 201b, 201c, and 201d, and a fourth phosphor is positioned at a discharge cell corresponding to at least one 201d of the rest address electrodes. The fourth phosphor may be a white phosphor.

For example, in only case that the RED discharge cell C1, the GREEN discharge cell C2, the BLUE discharge cell C3 are selected, the WHITE discharge cell C4 is selected. In other words, when the RED discharge cell C1, the GREEN discharge cell C2, the BLUE discharge cell C3 emit light at the same time, the WHITE discharge cell C4 emits light. As a result of an emission of light of the RED discharge cell C1, the GREEN discharge cell C2, the BLUE discharge cell C3, white light is generated, and the WHITE discharge cell C4 also emits white light. Accordingly, a brightness and a efficiency of light emission increase.

As illustrated in FIG. 5a, the plurality of the scan electrodes include a first scan electrode 101A and a second scan electrode 101B. some of the plurality of the discharge cells, i.e. the RED discharge cell C1 and the GREEN discharge cell C2, correspond to the first scan electrode 101A, and at least one, i.e. the BLUE discharge cell C3 and the WHITE discharge cell C4, of the rest discharge cells except for some of the plurality of the discharge cells corresponds to the second scan electrode 101B.

The disposement of discharge cells in FIG. 5b is the same as the disposement of discharge cells of the plasma display panel of FIG. 2. The plurality of the discharge cells C1, C2, C3 and C4 correspond to one 101A or 101B of the plurality of the scan electrodes. An operation of AND gate AND of FIG. 5b is the same as the operation of the AND gate of FIG. 5a, thus the detailed description of the operation of AND gate AND of FIG. 5b is omitted.

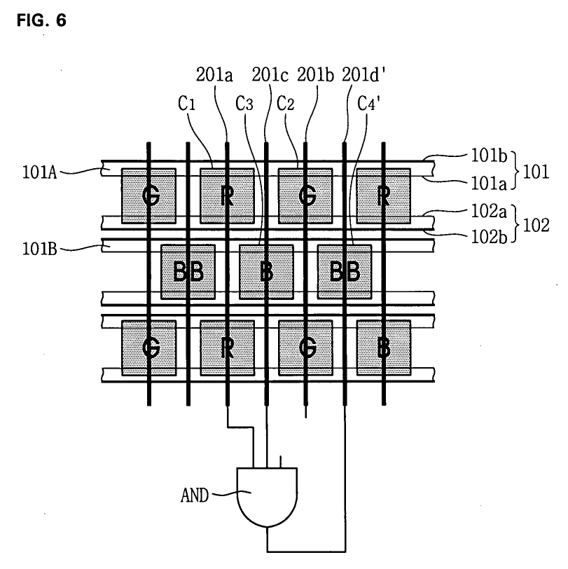

FIG. 6 illustrates another example of the operation of the first address electrode driver and the second address electrode driver of FIG. 4. In FIG. 5a, the RED discharge cell C1, the GREEN discharge cell C2, the BLUE discharge cell C3 and the WHITE discharge cell C4 constitute one pixel. In FIG. 6, the RED discharge cell C1, the GREEN discharge cell C2, the BLUE discharge cell C3 and another BLUE discharge cell C4′ constitutes one pixel.

An AND gate AND of FIG. 6 receives data pulses having high level supplied to some address electrodes 201a and 201c, and generates a data pulse supplied to the rest address electrode 201d′. A RED phosphor, A GREEN phosphor, A BLUE phosphor and another BLUE phosphor are respectively positioned in the RED discharge cell C1, the GREEN discharge cell C2, the BLUE discharge cell C3 and another BLUE discharge cell C4′.

The AND gate AND of FIG. 6 selects another BLUE discharge cell C4′ when the RED discharge cell C1 and the blue discharge cell C3 are selected during the address period. Accordingly, a brightness of blue light increases, and color of an image can be controlled.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display panel comprising:
a first panel including a plurality of scan electrodes;
a second panel including a plurality of address electrodes crossing the plurality of the scan electrodes;
a barrier rib partitioning four discharge cells corresponding to regions where at least one of the plurality of the scan electrodes cross the plurality of address electrodes; and
a plurality of phosphors emitting different lights each other from the four discharge cells.

2. The plasma display panel of claim 1, wherein
the plurality of phosphors include a red phosphor, a green phosphor, a blue phosphor, and a fourth phosphor.

3. The plasma display panel of claim 2, wherein
the fourth phosphor is a white phosphor.

4. The plasma display panel of claim 1, wherein
the plurality of scan electrodes includes a first scan electrode and a second scan electrode,
some of the four discharge cells correspond to the first scan electrode, and
the rest of the four discharge cells except for some discharge cells correspond to the second scan electrode.”

5. The plasma display panel of claim 1, wherein
the four discharge cells correspond to one scan electrode of the plurality of scan electrodes.

6. The plasma display panel of claim 1, wherein
each area of the discharge cells, which the barrier rib partitions, is substantially the same.

7. The plasma display panel of claim 1, wherein
a channel is formed at the barrier rib.

8. A plasma display apparatus comprising:
a plasma display panel including a plurality of discharge cells corresponding to areas where at least one of a plurality of scan electrodes crosses a plurality of address electrodes;
a scan driver supplying scan pulses to the plurality of the scan electrodes;
a first address driver supplying data pulses to some of the plurality of the address electrodes; and
a second address driver receiving the data pulses supplied to some of the plurality of the address electrodes and supplying data pulses to at least one of the rest address electrodes except for some of the plurality of the address electrodes.

9. The plasma display apparatus of claim 8, wherein
the second address driver receives the data pulses having high level supplied to some of the plurality of the address electrodes and supplies a data pulse having high level to at least one of the rest address electrodes.

10. The plasma display apparatus of claim 8, wherein
the second address driver includes an AND gate receives the data pulses having high level supplied to some of the plurality of the address electrodes and generates a data pulse having high level to the rest address electrodes.

11. The plasma display apparatus of claim 8, wherein
a red phosphor, a green phosphor and a blue phosphor are positioned at discharge cells corresponding to some of the plurality of the address electrodes, and
a fourth phosphor is positioned at a discharge cell corresponding to at least one of the rest address electrodes.

12. The plasma display apparatus of claim 11, wherein
the fourth phosphor is a white phosphor.

13. The plasma display apparatus of claim 8, wherein
the plurality of the scan electrodes include a first scan electrode and a second scan electrode,
some of the plurality of the discharge cells correspond to the first scan electrode, and
at least one of the rest discharge cells except for some of the plurality of the discharge cells corresponds to the second scan electrode.

14. The plasma display apparatus of claim 8, wherein
the plurality of the discharge cells correspond to one of the plurality of the scan electrodes.

15. The plasma display apparatus of claim 8, wherein
each of the the plurality of the discharge cells which the barrier rib partition is substantially the same each other.

16. The plasma display apparatus of claim 8, wherein
a channel is formed at the barrier rib.

17. A driving method of a plasma display apparatus including a plurality of discharge cells corresponding to areas where at least one of a plurality of scan electrodes crosses a plurality of address electrodes, comprising:
supplying scan pulses to the plurality of the scan electrodes;
supplying data pulses to some of the plurality of the address electrodes; and
receiving the data pulses supplied to some of the plurality of the address electrodes and supplying data pulses to at least one of the rest address electrodes except for some of the plurality of the address electrodes.

18. The driving method of the plasma display apparatus of claim 17, wherein
the data pulses having high level supplied to some of the plurality of the address electrodes are received and a data pulse having high level is supplied to at least one of the rest address electrodes.

19. The driving method of the plasma display apparatus of claim 17, wherein
a red phosphor, a green phosphor and a blue phosphor are positioned at discharge cells corresponding to some of the plurality of the address electrodes, and
a fourth phosphor is positioned at a discharge cell corresponding to at least one of the rest address electrodes.

20. The plasma display apparatus of claim 17, wherein
the fourth phosphor is a white phosphor.
